(19) United States
(12) Patent Application Publication
(10) Pub. No.: US 2018/0339355 A1
(43) Pub. Date: Nov. 29, 2018

(54) Method of Hardbanding Drill String Components and Related Drill String Components Thereof

(71) Applicants: Ryan Forbes, Leduc (CA); Darwin Botting, Leduc (CA); Brad Gibeau, Leduc (CA)

(72) Inventors: Ryan Forbes, Leduc (CA); Darwin Botting, Leduc (CA); Brad Gibeau, Leduc (CA)

(21) Appl. No.: 15/909,993

(22) Filed: Mar. 1, 2018

Related U.S. Application Data
(60) Provisional application No. 62/511,510, filed on May 26, 2017.

(51) Int. Cl. B23K 9/04; E21B 17/042; B23K 10/02; E21B 17/10; F16L 9/04

(52) U.S. Cl. CPC B23K 9/046; E21B 17/042; F16L 57/00; E21B 17/1085; F16L 9/042; B23K 10/027

(57) ABSTRACT

A method of applying non-magnetic semi-helical hardbanding to a non-magnetic drill collar used in well-drilling operations is disclosed herein. The method involves applying semi-helical bands using Plasma Transferred Arc (PTA), laser hardfacing, or a similar thermal-welding technique. At least one non-magnetic alloy is used to form a set of evenly spaced single blades around the circumference of the drill collar. The blades are arranged such that no single blade extends around the full circumference of the collar.

### CROSS REFERENCE TO RELATED APPLICATION

The present application is related to and claims priority to U.S. Provisional Patent Application No. 62/511,510 filed 2017 May 26, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of drilling accessories and more specifically relates to drill collars with helically arranged structures.

### 2. DESCRIPTION OF RELATED ART

Much of the world uses petroleum products. Oil is often extracted via surface wells and transported through pipes to a location suitable for refining. In the drilling of oil and gas wells with rotary rigs, the components forming the down-hole drill string are subjected to considerable wear. Drill collar sections are generally heavier than the other portions of the drill string and are particularly susceptible to wear associated with rotational and axial forces imposed on the collar while drilling and tripping in and out of a well.

Hardbanding is the process of depositing extra-hard alloys onto components of a drill string to protect the outer surfaces of the drill string components from abrasive wear associated with rotational drilling. Hardbanding is most commonly applied to the box end of drill pipe tool joints, but may also be applied to drill collars, heavy weight drill pipe, and other down-hole members of a drill string. Hardbanding may be applied to new parts to increase their service life, or to used or older parts to extend the working life of these components. In traditional hardbanding procedures, one or more continuous rings of a wear-resistant alloy are applied to the outer circumference of a drill string component. Although many oil and gas production wells have been drilled using drill string components with traditional hardbanding, the drilling industry has become increasingly aware of the significate and costly problems associated with the use of customary hardbanding techniques. Among these are cracking failures propagating into the base material, increased down-hole drag, sticking of drill string components with the casing, restricted circulation of drilling fluids around the annular hardbanding region, and high casing wear. Clearly, a need exists for new and improved hardbanding methods and apparatus designed to overcome the above-noted problems.

Various attempts have been made to solve problems found in drilling accessory art. Among these are found in U.S. Pub. No. 2015/306,703 to Hamre, which relates to a method of hardbanding a tubular component and a tubular component hardbanded in accordance with the method. The described method involves placing a helical band of hardbanding material forming spaced coils around an exterior wear surface of a body of the tubular component. The helical band has a helix angle of not less than 5 degrees relative to a longitudinal axis of the tubular component and the spacing between the coils is a minimum of 18 mm. This prior art is representative of conventional hardbanding, wherein the hardbanding extends continuously around the full circumference of the tubular component. Such conventional hardbanding arrangements give rise to the conditions noted above, which result in costly repairs and delays in production.

### BRIEF SUMMARY OF THE INVENTION

In view of the foregoing disadvantages inherent in the known drilling accessories art, the present disclosure provides a novel method of hardbanding drill string components and related drill string components thereof. The general purpose of the present disclosure, which will be described subsequently in greater detail, is to provide a method of hardbanding a non-magnetic drill collar component. The method involves applying semi-helical bands using Plasma Transferred Arc (PTA), laser hardfacing, or a similar thermal-welding technique. At least one tungsten carbide alloy is used to form evenly spaced single blades around the circumference of the drill collar. The bands are structured and arranged such that no single band extends around the full circumference of the collar.

A method of applying non-magnetic semi-helical hardbanding to a non-magnetic drill collar used in well-drilling operations is disclosed herein. The method includes receiving a non-magnetic drill collar having a longitudinally extending tubular wall, an outer peripheral surface, an inner bore defining a longitudinal axis, and opposing ends, each opposing end may include a coupler configured to enable coupling of the non-magnetic drill collar to a rotary drill string; applying a raised pattern of semi-helical bands evenly spaced about the outer peripheral surface of the non-magnetic drill collar using at least one thermal process, each such semi-helical band may comprise at least one non-magnetic hardfacing composition applied to the outer peripheral surface, the at least one non-magnetic hardfacing composition containing tungsten carbide, a length of at least about three inches, a width of at least about 0.5 inch, a spacing between the helical bands of at least about 0.9 inch, and a helical-band angle not less than about 30 degrees relative to the longitudinal axis.

A non-magnetic drill collar for use in well-drilling operations is also disclosed herein. The non-magnetic drill collar comprises a longitudinally extending tubular wall may have an outer peripheral surface, an inner bore defining a longitudinal axis, and opposing ends, each opposing end may include a coupler configured to enable coupling of the non-magnetic drill collar to a rotary drill string; a raised pattern of helical bands evenly spaced about the outer peripheral surface, each the semi-helical band consisting of at least one non-magnetic hardfacing composition applied to the outer peripheral surface, the at least one non-magnetic hardfacing composition containing tungsten carbide, a length of at least about three inches, a width of at least about 0.5 inch, a spacing between the helical bands of at least about 0.9 inch, and a helical-band angle not less than about 30 degrees relative to the longitudinal axis. The non-magnetic drill collar may be constructed substantially of stainless steel. The non-magnetic drill collar may further comprise an intermediate buffer layer interposed between the stainless steel of the non-magnetic drill collar and the at least one non-magnetic hardfacing composition forming the non-magnetic helical bands, wherein the intermediate buffer layer comprises at least one non-magnetic metallic alloy. The intermediate buffer layer may be thermally fused with the outer peripheral surface; and the at least one non-magnetic hardfacing composition may be thermally fused with the intermediate buffer layer. The intermediate buffer layer may have a thickness of between about 0.060 inch and about 0.090 inch. The helical bands may project outwardly of the outer peripheral surface not more than about 0.25 inch. The coupler may be configured to form a threaded connection. The non-magnetic drill collar may further comprise set of instructions; and wherein the non-magnetic drill collar may be arranged as a kit.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method of hardbanding drill string components and related drill string components thereof, constructed and operative according to the teachings of the present disclosure.

FIG. 1 is elevational view, illustrating a non-magnetic drill collar with non-magnetic semi-helical hardbanding applied using a method of the present disclosure, according to an embodiment of the disclosure.

FIG. 2 is the elevational Detail View 2 of FIG. 1, illustrating the non-magnetic semi-helical hardbanding applied to a tool joint of the non-magnetic drill collar, according to an embodiment of the present disclosure.

FIG. 3 is the elevational Detail View 3 of FIG. 1, illustrating the non-magnetic semi-helical hardbanding applied to a center upset of the non-magnetic drill collar, according to an embodiment of the present disclosure.

FIG. 4 is a detail view, enlarged for clarity, of the non-magnetic semi-helical hardbanding of FIG. 2, according to an embodiment of the present disclosure.

FIG. 5 is elevational view, illustrating an alternate non-magnetic drill collar with the non-magnetic semi-helical hardbanding applied in a staggered pattern using the method of the present disclosure, according to an embodiment of the disclosure.

FIG. 6 is the elevational Detail View 6 of FIG. 5, illustrating the non-magnetic semi-helical hardbanding of FIG. 5 applied to a tool joint of the alternate non-magnetic drill collar, according to an embodiment of the present disclosure.

FIG. 7 is the elevational Detail View 7 of FIG. 5, illustrating the non-magnetic semi-helical hardbanding of FIG. 5 applied to a center upset of the alternate non-magnetic drill collar, according to an embodiment of the present disclosure.

FIG. 8 is a detail view, enlarged for clarity, of the non-magnetic semi-helical hardbanding of FIG. 6, according to an embodiment of the present disclosure.

FIG. 9 is a detail view, enlarged for clarity, of the non-magnetic semi-helical hardbanding of FIG. 1 through FIG. 8, according to the embodiments of the present disclosure.

FIG. 10 is an elevational view, in partial section, illustrating a coupler of the non-magnetic drill collar, according to embodiments of the present disclosure.

FIG. 11 is an elevational view, in partial section, of an alternate non-magnetic drill collar used in well-drilling operations, according to embodiments of the present disclosure.

FIG. 12 is an elevational view, in partial section, of an alternate non-magnetic drill collar used in well-drilling operations, according to embodiments of the present disclosure.

FIG. 13 is an elevational view, in partial section, of an alternate non-magnetic drill collar used in well-drilling operations, according to embodiments of the present disclosure.

FIG. 14 is a flow diagram illustrating a method of applying non-magnetic semi-helical hardbanding to a non-magnetic drill collar used in well-drilling operations, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a drilling accessories and more particularly to a method of hardbanding drill string components and related drill string components thereof as used to improve the drill collars with helically arranged structures.

Generally, a method of hardbanding a non-magnetic drill collar component is disclosed herein. The method involves applying semi-helical bands (also referred to herein as “Helibands” or helical “blades”) of hard non-magnetic alloy material forming evenly spaced single blades around the circumference of the drill collar. Though experimentation, unexpected performance increases were achieved utilizing the following combination:
helical angles not less than about 30 degrees relative to longitudinal axis of the non-magnetic drill collar,
a minimum spacing between the blades of about 0.9 inch (25 millimeters),
a minimum blade length of about 3 inches, and
a blade width not less than ½ inch.

The resulting Heliband was found to significantly increase the service life of the non-magnetic drill collars, when compared to existing drill collars utilizing customary hardbanding. In particular, drill collars modified by the presently-disclosed method showed significant increases in the longevity of the base material, which protected the collars from extreme wear. In addition, increases in the circulation of drilling fluid flowing past the collar were observed with semi-helical hardbanding when compared to customary circumferential and full-helical hardbanding of the known art. A further advantage was discovered when the weld design of the present disclosure was found to reduce cracking in the base material. The underlying mechanism of this unexpected discovery is not fully understood; however, it is believed that the atypical longitudinal orientation of the welds forming the Heliband combined with the applicant's sequential welding procedure reduces and/or beneficially alters thermal stresses in the base material after welding. This is in contrast to the disadvantageous changes in base-material properties produced by standard circumferential welding or spiral hardband welding.

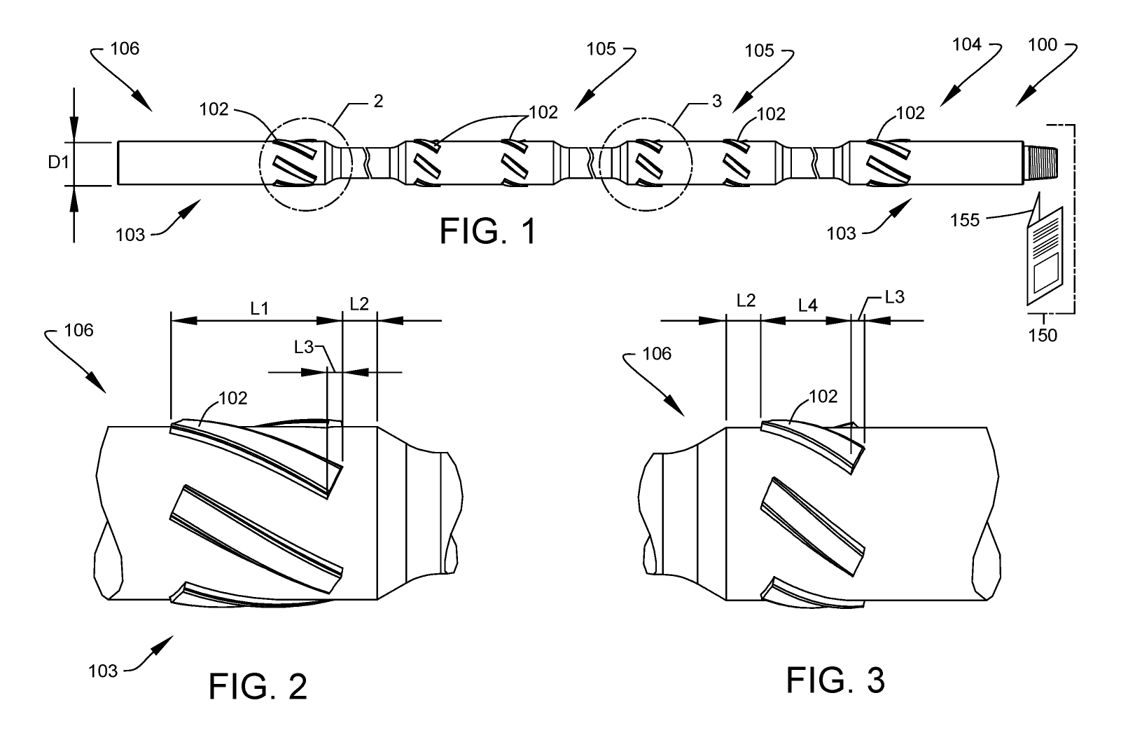

Referring now more specifically to the drawings by numerals of reference, there is shown in FIGS. 1-13, various views describing a hardbanding system 100 including a method of applying non-magnetic semi-helical hardbanding 102 to non-magnetic drill string components 104 used in well-drilling operations and to the resulting products produced by the method. The presently-disclosed drill collar hardbanding highly effective in retarding the wear of the collar outside diameter (OD) that occurs during normal open-hole drilling.

To gain an understanding of the method disclosed herein, it is helpful to first describe the improved components produced by the method. In this regard, FIG. 1 shows non-magnetic semi-helical hardbanding 102 applied to a non-magnetic drill collar 106, according to an embodiment of the present disclosure. The body of the non-magnetic drill collar 106 may be constructed from a rigid and durable non-magnetic metallic composition. In one embodiment, the non-magnetic drill collar 106 is constructed substantially of stainless steel.

FIG. 2 is the elevational Detail View 2 of FIG. 1, illustrating the non-magnetic semi-helical hardbanding 102 applied to a tool joint 103 of the non-magnetic drill collar 106, according to an embodiment of the present disclosure. FIG. 3 is the elevational Detail View 3 of FIG. 1, illustrating the non-magnetic semi-helical hardbanding 102 applied to a center upset 105 of the non-magnetic drill collar 106, according to an embodiment of the present disclosure.

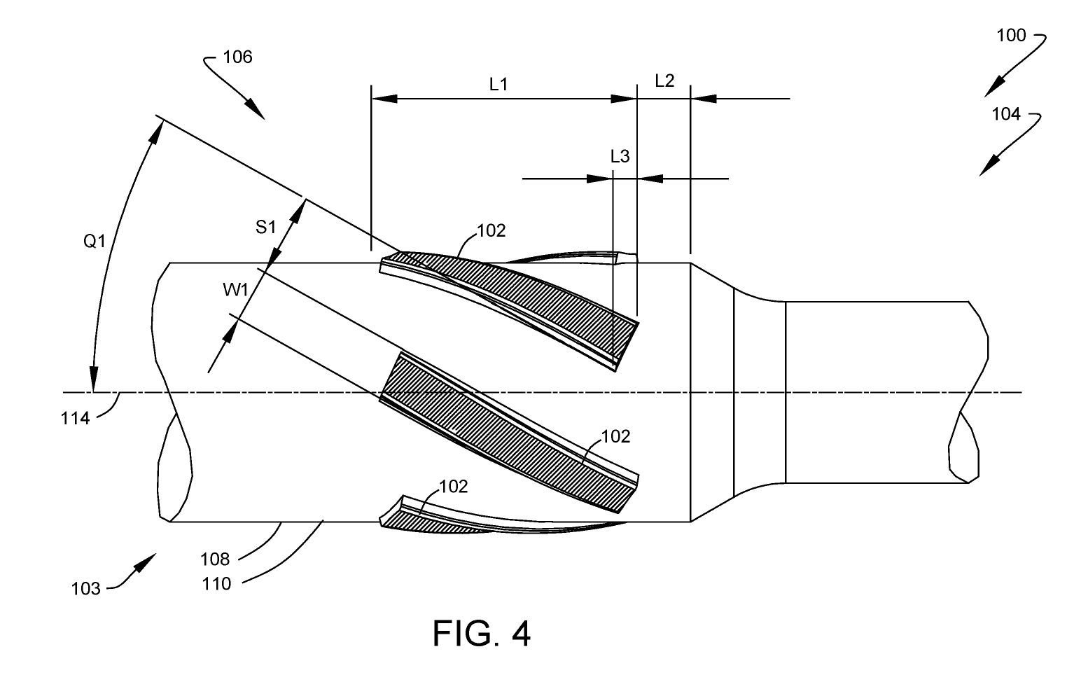

FIG. 4 is a detail view, enlarged for clarity, of the non-magnetic semi-helical hardbanding 102 of FIG. 2, according to the embodiment of FIG. 1. As illustrated, the non-magnetic drill collar 106 may include a longitudinally extending tubular wall 108 having an outer peripheral surface 110, and an inner bore 112 (see FIG. 10) defining a longitudinal axis 114, as shown. The center upset 105 has an increased the cross sectional area, as shown.

The non-magnetic semi-helical hardbanding 102 of the non-magnetic drill collar 106 may include a raised pattern of non-magnetic semi-helical hardbanding 102, which are evenly spaced about the outer peripheral surface 110, as shown. The bands are structured and arranged such that no single band extends around the full circumference of the collar, as shown.

Each semi-helical hardband 122 may have a length L1 (at tool joint) or L4 (at center upset) of at least about three inches, a width W1 of at least about 0.5 inch, a spacing S1, between the semi-helical hardbands 122, of at least about 0.9 inch (25 millimeters), and a helical-band angle Q1 not less than about 30 degrees relative to the longitudinal axis 114. This preferred arrangement assures that the outer peripheral surface 110 remains fully protected, without the use of restrictive circumferential banding. Table 1 lists preferred arrangements of commonly-used configurations of the presently-disclosed system.

In reference to FIG. 4, each semi-helical hardband 122 may be located at a distance L2 of at least about one inch from the transition shoulder 109. Each end of the semi-helical hardbands 122 terminates at an angle relative to the longitudinal axis 114, which places the corners of the bands at a separation distance L3 of about ½ inch (as measured between circumferential lines intersecting the two corners).

The collars may be supplied in a range of useful lengths and outer diameters. Outer diameters Dl may range between 3½ inches and 11 inches. Inner bores 112 may range between 1½ inches and 3 inches. Collars lengths may extend to 30 feet or more, depending on drilling requirements. Table 1 lists preferred arrangements of commonly-used configurations of the presently-disclosed system.

TABLE 1
Blade and Pitch Lengths

| | Blade | Blade | Blade | Blade |
|---|---|---|---|---|
| Collar Diameter (D1) | Location | Count | Length | Pitch |
| 5 Inch | Tool Joint | 5 | 5″ [L1] | 27.83″ |
| | Center Upset | 5 | 3″ [L4] | 19.48″ |
| 6½ To 7 Inch | Tool Joint | 6 | 5″ [L1] | 33.97″ |
| | Center Upset | 6 | 4″ [L4] | 28.86″ |
| 8 Inch | Tool Joint | 7 | 5″ [L1] | 40.19″ |
| | Center Upset | 7 | 4″ [L4] | 34.42″ |
| 9 Inch | Tool Joint | 8 | 5″ [L1] | 45.61″ |
| | Center Upset | 8 | 4″ [L4] | 38.98″ |

Referring to Table 1, it is noted that the band (blade) lengths of the fourth column reference the nominal length of each band. The blade pitch of the fifth column refers to the aggregate length of all blades when combined. Upon reading this specification, it should be appreciated that, under appropriate circumstances, considering such issues as user preferences, design preference, structural requirements, marketing preferences, cost, available materials, technological advances, etc., other hardband arrangements such as, for example, utilization of other lengths, applying alternate numbers of blades, etc., may be sufficient.

Referring again to FIG. 3, each semi-helical hardband 122 of the center upset 105 may have a length L4 of at least about three inches, a width W1 of at least about 0.5 inch, a spacing S1, between the semi-helical hardbands 122, of at least about 0.9 inch (25 millimeters), and a helical-band angle Q1 not less than about 30 degrees relative to the longitudinal axis 114. As above, each end of the semi-helical hardbands 122 terminates at an angle relative to the longitudinal axis 114, as shown. This angle places the corners of the bands at a separation distance L3 of about ½ inch (as measured between circumferential lines intersecting the two corners).

Each semi-helical hardband 122 may consist of at least one non-magnetic hardfacing composition applied to the outer peripheral surface 110. Preferred non-magnetic hardfacing compositions contain at least one ultra-hard wear-resistant material, such as tungsten carbide. Suitable compositions include blends of tungsten carbide in a non-magnetic nickel base alloy powder matrix. In one method of the present disclosure, the hardbanding composition is added to a molten weld puddle to obtain uniform distribution of the tungsten carbide particles, as further described below. Table 2 shows one non-magnetic hardfacing composition suitable to produce the semi-helical hardbands 122.

TABLE 2

| | |
|---|---|
| Matrix (50%) Percent by weight | Carbide (50%) |

| | | | | | |
|---|---|---|---|---|---|
| C | 0.114 | Mn | 0.078 | Free C | 0.030 |
| B | 1.138 | P | 0.005 | C | 3.820 |
| Si | 2.246 | S | 0.002 | Fe | 0.280 |
| Fe | 3.475 | W | 1.791 | W | Balance |
| Cr | 19.367 | Cu | 0.988 | | |
| Mo | 12.917 | Ni | Balance | | |

Referring again to FIG. 1, the non-magnetic drill collar 106 may be supplied with a set of instructions 155 and wherein the non-magnetic drill collar 106 may be arranged as a kit 150. The instructions 155 may detail functional relationships in relation to the structure of the embodiment of the system (such that the embodiment can be used, maintained, or the like, in a preferred manner).

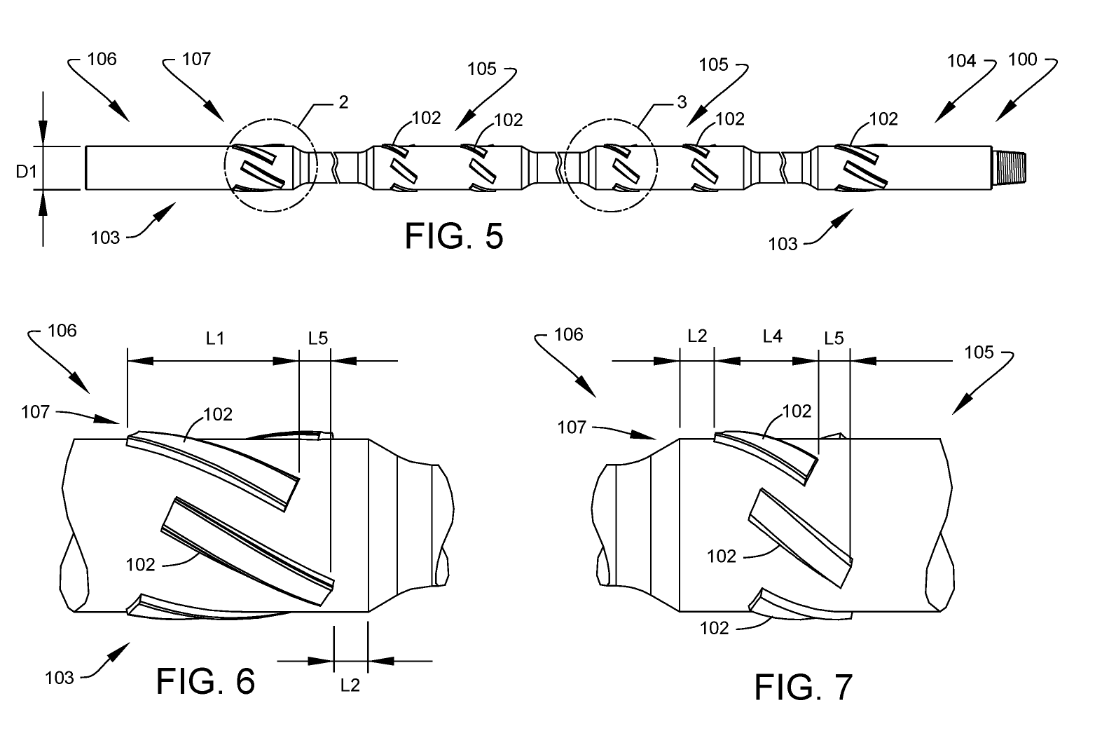

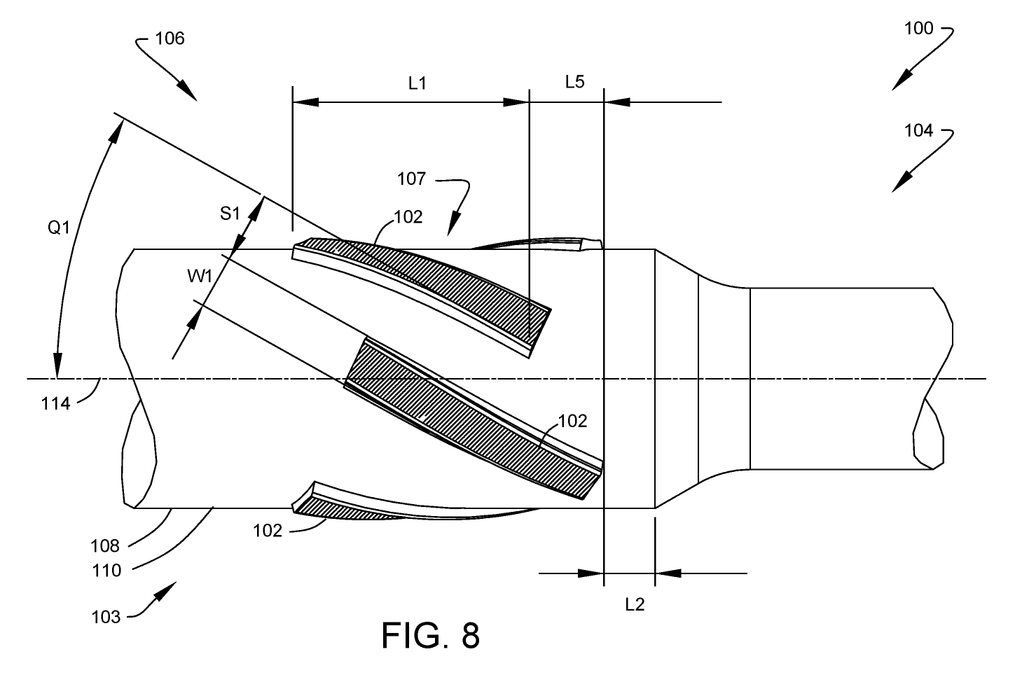

FIG. 5 is elevational view, illustrating an alternate non-magnetic drill collar 106 with non-magnetic semi-helical hardbanding 102 applied in a staggered pattern 107 using the method of the present disclosure, according to an embodiment of the disclosure. FIG. 6 is the elevational Detail View 6 of FIG. 5, illustrating the staggered pattern 107 of the non-magnetic semi-helical hardbanding 102 applied to the tool joint 103 of the alternate non-magnetic drill collar 106. FIG. 7 is the elevational Detail View 7 of FIG. 5, illustrating a staggered pattern 107 of non-magnetic semi-helical hardbanding 102 applied to a center upset 105 of the alternate non-magnetic drill collar 106, according to another embodiment of the present disclosure. FIG. 8 is a detail view, enlarged for clarity, of the staggered pattern 107 of non-magnetic semi-helical hardbanding 102 of FIG. 6.

Each staggered semi-helical hardband 122 have a length L1 (at tool joint) or L4 (at center upset) of at least about three inches. As above, each semi-helical hardband 122 may have a width W1 of at least about 0.5 inch, a spacing S1, between the semi-helical hardbands 122, of at least about 0.9 inch (25 millimeters), and a helical-band angle Q1 not less than about 30 degrees relative to the longitudinal axis 114. The staggered pattern 107 is generated by offsetting the ends of the adjacent bands a distance L5 of about one inch, as shown.

In reference to FIG. 8, each semi-helical hardband 122 may be located at a distance L2 of at least about one inch from the transition shoulder 109. Each end of the semi-helical hardbands 122 terminates at an angle relative to the longitudinal axis 114, as shown.

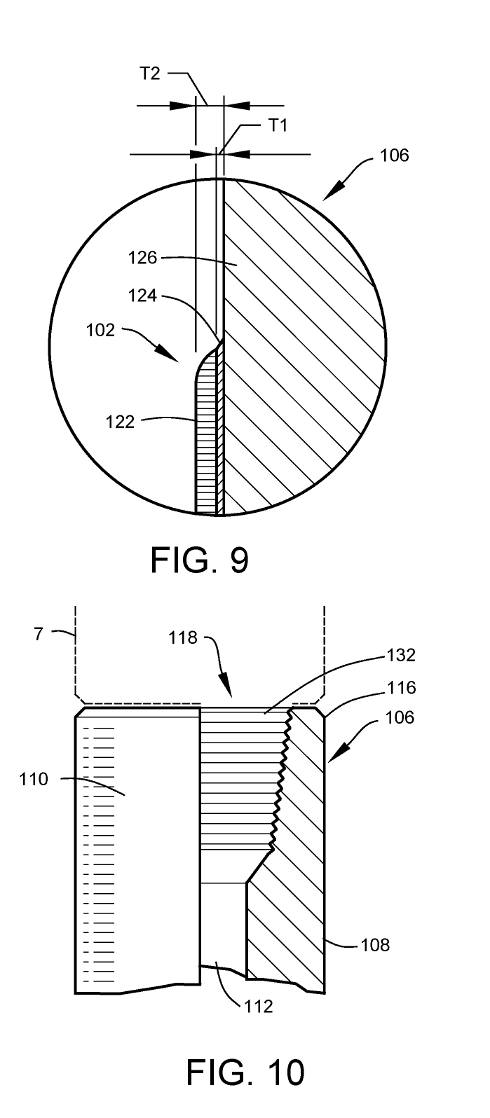

FIG. 9 is a detail view, enlarged for clarity, of the non-magnetic semi-helical hardbanding 102 applied to the non-magnetic drill collars of FIG. 1 through FIG. 8, according to an embodiment of the present disclosure. The non-magnetic drill collar 106 may further include an intermediate buffer layer 124 interposed between the stainless steel base metal 126 of the non-magnetic drill collar and the non-magnetic hardfacing composition forming the semi-helical hardbands 122, as shown. The intermediate buffer layer 124 may consist of at least one non-magnetic metallic alloy. Table 3 shows one buffer composition suitable for providing the intermediate buffer layer 124.

TABLE 3

| | |
|---|---|
| Matrix (100%) Percent by weight | Carbide (0%) |

| | | | | | |
|---|---|---|---|---|---|
| C | 0.113 | Mn | 0.159 | Free C | — |
| B | 1.119 | P | 0.005 | C | — |
| Si | 2.143 | W | 1.615 | Fe | — |
| Fe | 3.461 | Cu | 0.995 | W | — |
| Cr | 19.561 | Co | 0.004 | | |
| Mo | 12.857 | V | 0.001 | | |
| Ni | Balance | | | | |

In one embodiment of the present disclosure, the intermediate buffer layer 124 is thermally applied to the outer peripheral surface 110 and the non-magnetic hardfacing composition is thermally fused with the intermediate buffer layer 124, as shown. The intermediate buffer layer 124 may have a thickness T1 of between about 0.060 inch and about 0.090 inch. In one embodiment of the present disclosure, the non-magnetic non-magnetic semi-helical hardbanding 102 may be flush or project outwardly a distance T2 from the outer peripheral surface 110 up to about about 0.25 inch.

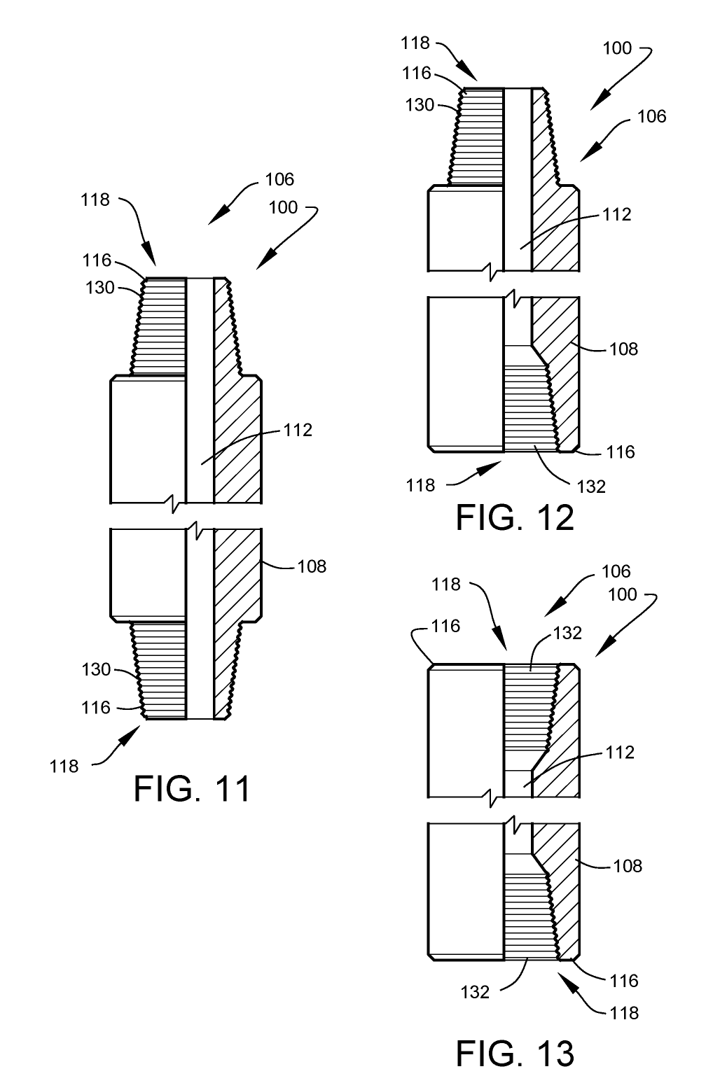

FIG. 10 is an elevational view, in partial section, illustrating a coupler 118 of the non-magnetic drill collar 106, according to embodiments of the present disclosure. Each opposing end 116 of the collar may include a coupler 118 enabling the coupling of the non-magnetic drill collar 106 to components of a rotary drill string 7 (indicated by the dashed-line depiction). Each coupler 118 may be adapted to form a threaded connection. More specifically, the couplers 118 may include industry-standard threaded female box-type couplers 132, as shown in FIG. 10, and industry-standard threaded male pin-type couplers 130, as shown in FIG. 11 and FIG. 12.

FIG. 11 is an elevational view, in partial section, of an alternate non-magnetic drill collar 106, according to embodiments of the present disclosure. In the depicted embodiment, the collar includes two industry-standard threaded male pin-type couplers 130. FIG. 12 is an elevational view, in partial section, of a non-magnetic drill collar 106, according to another embodiment of the present disclosure. In this alternate embodiment, the collar includes both an industry-standard threaded female box-type coupler 132 and industry-standard threaded male pin-type coupler 130, as shown. FIG. 13 is an elevational view, in partial section, of a non-magnetic drill collar 106, according to another embodiment of the present disclosure. In this alternate embodiment, each opposing end 116 of the collar includes an industry-standard threaded female box-type coupler 132, as shown. In the present disclosure, “industry-standard” may include standards published by the American Petroleum Institute (API) Committee on Standardization of Tubular Goods.

### General Overview of Weld Procedure Using Plasma Transferred Arc (PTA) and Laser

The following description outlines the process and procedure for the application of Heliband on a new or used non-magnetic drill collars. PTA/Laser Helibands may include the application of a buffer or intermediary layer of alloy material, which is designed to prevent the intermingling of the non-magnetic tungsten carbide hardface materials with the substrate or drill collars base material.

The application of Helibands on the surface of a non-magnetic drill collar provides a wear resistant, hard erosion resistant surface that lengthens the life of the drill collar.

A. Drill Collar Preparation

The drill collars must be clean of all rust, dust, dirt, paint and any other foreign materials that may prohibit the resulting application of Helibands. In addition, the base material must be devoid of porosity or visible cracking.

Drill collars are mounted onto a PTA welding bed and water plugs are installed within the end bore openings, as required. The drill collars are then secured into a rotational chuck, as required to ensure direct rotation of the drill collar will not fail during the welding process. An internal water cooling flush is activated so as to ensure sufficient cooling is taking place during the welding process.

The drill collars are clearly marked with the desired location of the hardbands as per the above-described hardbanding pattern of the presently-disclosed method and instructed by the end user. In cases where a pre-machined hardband window location is present, this part of the procedure becomes redundant.

B. Application of Non-Magnetic Helibands

The PTA system operator will set the system with a pre-determined setting selected for the size and type of bands being applied. These pre-determined settings will include the following:

Voltage: 27 to 32 Volts

Amperage: 85 to 120 Amps

Powder Feed Rate: 10 to 30%

Powder Gas Flow: 6 to 12 PSI

Arc Gas: 30 PSI

Welding Arc Gas: 30 PSI

Weld rotational speed: 1 to 10 RPM

Although most new drill collars are received in a crack-free condition, it is recommended practice to inspect each drill collar using dye penetrant testing in the hardband area prior to beginning the welding process.

Once the appropriate pre-sets are selected and the dye penetrant testing has been completed, the operator warms the surface of the drill collar with the heated water flush. The target surface temperature of the drill collar in the hardband welding location prior to welding is between about 100 and 125 degrees Fahrenheit, and may tested after one minute of soak time to ensure adequate pre-heating has taken place. The operator is careful not to test the temperature of the drill collar in the actual location of the hardband. The operator may test the temperature using, for example, a temperature indicating stick (formulated to melt at a specific temperature, such as Tempil brand products produced by LA-CO Industries of Elk Grove Village, Ill.) with the stick held at least about ½ inch away from the location of the hardband, so as to ensure that the surface location is not contaminated by the stick materials. Electronic thermal testing on non-magnetic drill collars is not accepted as the substrate material is generally considered to be too reflective and will not provide an accurate temperature reading. Wax melt test sticks are the only acceptable method for testing temperature.

C. Application of the Buffer Layer

As mentioned in the prior overview section of this procedure, a PTA application of a buffer-material layer is required to ensure that the hardband does not intermingle with the substrate material when the welding process is taking place.

The alloy buffer layer may be applied in thicknesses ranging between about 0.06 inch and 0.09 inch. The width may be about 1¼ inches, or as necessary to meet the end user's requirements. All system settings may be pre-set to ensure sufficient thickness so as to prevent the hardband from intermingling with the substrate.

The system pre-sets allow the operator to set the PTA welding head to the desired hardband location along the length of the drill collar and proceed with the welding process in accordance with a selected configuration as disclosed herein.

Depending on the outside diameter (OD) size of the drill collar, five to eight semi-helical blade hardbands three to five inches long are applied in close proximity at about 1 inch to 1½ inch spacing (with a minimum spacing of about of 18 mm) between bands in a prescribed area along the length of the drill collar.

While completing the welding, the PTA system operator will intentionally move the welding head from one prescribed hardbanding location to another along the length of the drill collar so as to prevent the drill collar from overheating in any one area during the welding process. The intention of this movement prevents the drill collar from being heated in any location above a maximum upper limit temperature of about 500 degrees Fahrenheit, or as designated by the end user. In cases where hardbands are applied within close proximity the operator must ensure that the temperature of the drill collar returns to 100 to 125 degrees Fahrenheit prior to proceeding with the next buffer layer bead.

The water flush cooling of the drill collar is designed to remove heat from the main body of the drill collar as the welding process is taking place. The rotation of the drill collar in the system should not be stopped, until the welding process has been completed. This will ensure that the system is not quenching one area/side (i.e., the lower portion) of the drill collar and not the entire drill collar.

D. Application of the PTA Hardface Layer

Similar temperature precautions used during the application of the buffer layer are employed during the application of the tungsten carbide hardband layer.

The application of the Non-magnetic Tungsten Carbide hardfacing materials are be applied on top of the preceding buffer layer. These bands may be about one inch wide and should not be applied to a thickness of more than about 3/16 inch above the surface of the drill-collar substrate. The hardbands are convex shaped and should not have square shoulders. Convex shaped hardbands have been found to allow for better flow of drilling fluids over the bands and will produce less mud ring grooving below the helical blades. In cases where the end user requires the Helibands to be wider than one inch, the operator will weld only one inch wide segments at a time in order to allow for the drill collar to cool to an acceptable level prior to proceeding on to the next bead. The buffer layer may be cleaned with a stainless-steel wire wheel to remove any oxides or welding dust/smoke from the surface of the buffer layer.

Welding of the helical blades takes place only after the required parameters are input into the PTA system. Once the parameters are in place, the operator moves the welding head into the proper position on top of the buffer layer and commences the welding process. Again, the operator will ensure proper temperature levels are achieved prior to commencing with subsequent bands and will proceed when ready until all hardbanding is completed. After welding the collar may be wrapped in a thermally-insulated material to the rate at which the collar cools.

E. Preparation of the Drill Collar for Post Welding Delivery Back to the End User

Post welding cleaning of the bands with the stainless-steel wire wheel is required. Once the cleaning of the drill collar has been completed, the drill collar will be Dye Penetrant checked at the hardband areas to ensure that no cracking of the base metal has occurred during the welding process. Once the Dye Penetrant testing has been completed, and the drill collar returns to ambient temperature, the drill collar is ready to be shipped back to the end user.

This preferred hardbanding arrangement allows drilling fluid to pass between the blades, enhances the cleaning action of the hole while drilling, reduces erosion, and the formation of mud rings. Furthermore, use of the presently-disclosed hardbanding reduces the chance of the drill string component to get differentially stuck. These advantages increase drilling performance to producing quicker total depth (TD) times.

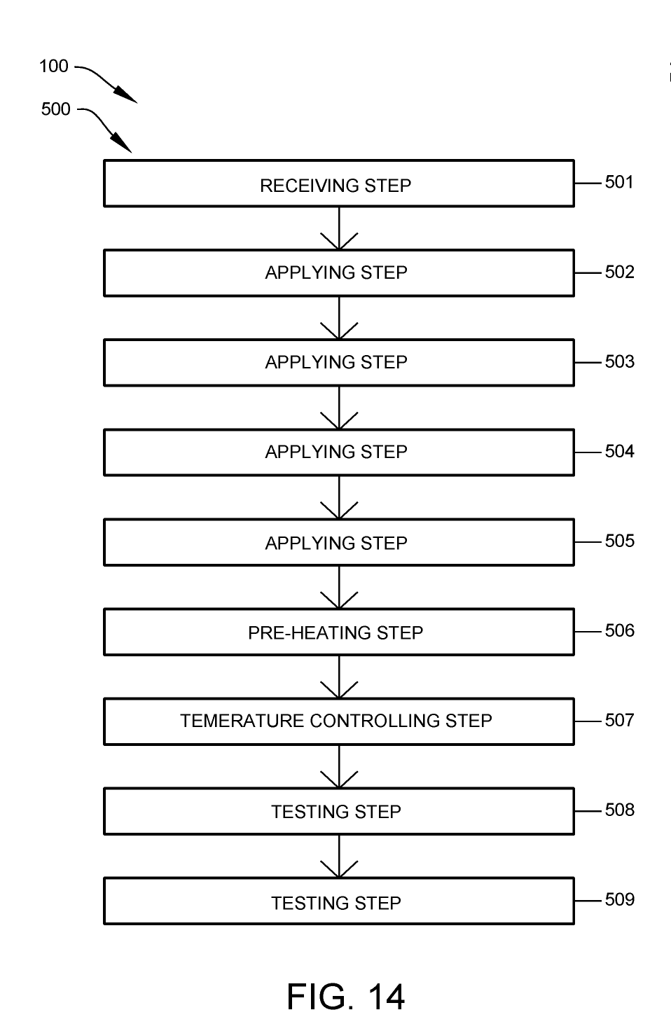

FIG. 14 is a flow diagram illustrating a method 500 of applying non-magnetic semi-helical hardbanding to a non-magnetic drill collar used in well-drilling operations, according to an embodiment of the present disclosure. As illustrated, the method 500 may include the steps of: step one 501, receiving a non-magnetic drill collar having a longitudinally extending tubular wall, an outer peripheral surface, an inner bore defining a longitudinal axis, and opposing ends, each opposing end may include a coupler configured to enable coupling of the non-magnetic drill collar to a rotary drill string; step 502, applying a raised pattern of helical bands evenly spaced about the outer peripheral surface of the non-magnetic drill collar using at least one thermal process, each such semi-helical band comprising at least one non-magnetic hardfacing composition applied to the outer peripheral surface, the at least one non-magnetic hardfacing composition containing tungsten carbide, a length of at least about three inches, a width of at least about 0.5 inch, a spacing between the helical bands of at least about 0.9 inch, and a helical-band angle not less than about 30 degrees relative to the longitudinal axis. Upon reading this specification, it should be appreciated that, under appropriate circumstances, considering such issues as user preferences, design preference, structural requirements, marketing preferences, cost, available materials, technological advances, etc., other hardband arrangements such as, for example, utilization of other compositions, applying alternate widths, applying alternate spacing between the helical bands, applying alternate helical-band angles, etc., may be sufficient

In addition, the method 500 may include the step 503 of applying the raised pattern of helical bands using at least one thermal process wherein the thermal process includes the use of a plasma transferred arc. Furthermore, the method 500 may include step 504 of applying the raised pattern of helical bands using at least one thermal process, the thermal process including a laser cladding process. The method 500 may further include the proceeding step 505 of applying an intermediate buffer layer interposed between the non-magnetic drill collar and the at least one non-magnetic hardfacing composition forming the non-magnetic helical bands, wherein the intermediate buffer layer includes at least one non-magnetic metallic alloy applied in a thickness of between about 0.060 inch and about 0.090 inch. The method 500 may further include the step 506 of preheating the non-magnetic drill collar to between about 100 and about 125 degrees Fahrenheit prior to applying the non-magnetic helical bands. In addition, the method 500 may further include the step 507 of controlling the temperature of the non-metallic collar during the application of the non-magnetic helical bands by a time-limited transfer of heat between the at least one thermal process and the non-metallic collar using non-contiguous applications of the at least one non-magnetic hardfacing composition at separated application points along the outer peripheral surface scheduled to receive the non-magnetic helical bands. The method 500 may further include the prior step 508 of dye penetrant testing the non-magnetic helical bands after application to the non-magnetic drill collar. Moreover, the method 500 may further include the step 509 of dye penetrant testing the outer peripheral surface prior to applying the non-magnetic helical bands.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of applying non-magnetic semi-helical hardbanding to a non-magnetic drill collar used in well-drilling operations, the method comprising the steps of:
receiving a non-magnetic drill collar having a longitudinally extending tubular wall, an outer peripheral surface, an inner bore defining a longitudinal axis, and opposing ends, each opposing end including a coupler configured to enable coupling of said non-magnetic drill collar to a rotary drill string;
applying a raised pattern of helical bands evenly spaced about the outer peripheral surface of the non-magnetic drill collar using at least one thermal process, each such helical band comprising
at least one non-magnetic hardfacing composition applied to said outer peripheral surface, said at least one non-magnetic hardfacing composition containing tungsten carbide,
a length of at least about three inches,
a width of at least about 0.5 inch,
a spacing between said helical bands of at least about 0.9 inch, and
a helical-band angle not less than about 30 degrees relative to said longitudinal axis.

2. The method of claim 1, wherein the step of applying the raised pattern of helical bands using at least one thermal process includes the use of a plasma transferred arc.

3. The method of claim 1, wherein the step of applying the raised pattern of helical bands using at least one thermal process includes the use of a laser cladding process.

4. The method of claim 1, further comprising the proceeding step of applying an intermediate buffer layer interposed between the non-magnetic drill collar and the at least one non-magnetic hardfacing composition forming the non-magnetic helical bands, wherein the intermediate buffer layer comprises at least one non-magnetic metallic alloy having an applied thickness of between about 0.060 inch and about 0.090 inch.

5. The method of claim 1, further comprising the step of preheating the non-magnetic drill collar to between about 100 and about 125 degrees Fahrenheit prior to applying the non-magnetic helical bands.

6. The method of claim 1, further comprising the steps of controlling the temperature of the non-metallic collar during the application of the non-magnetic helical bands by a time-limited transfer of heat between the at least one thermal process and the non-metallic collar using non-contiguous applications of the at least one non-magnetic hardfacing composition at separated application points along the outer peripheral surface scheduled to receive the non-magnetic helical bands.

7. The method of claim 1, further comprising the prior step of dye penetrant testing the non-magnetic helical bands after application to the non-magnetic drill collar.

8. The method of claim 1, further comprising the step of dye penetrant testing the outer peripheral surface prior to applying the non-magnetic helical bands.

9. A non-magnetic drill collar for use in well-drilling operations, said non-magnetic drill collar comprising:
a longitudinally extending tubular wall having an outer peripheral surface, an inner bore defining a longitudinal axis, and opposing ends, each opposing end including a coupler configured to enable coupling of said non-magnetic drill collar to a rotary drill string;
a raised pattern of helical bands evenly spaced about said outer peripheral surface, each said helical band consisting of at least one non-magnetic hardfacing composition applied to said outer peripheral surface, said at least one non-magnetic hardfacing composition containing tungsten carbide,
a length of at least about three inches,
a width of at least about 0.5 inch,
a spacing between said helical bands of at least about 0.9 inch, and
a helical-band angle not less than about 30 degrees relative to said longitudinal axis.

10. The non-magnetic drill collar of claim 9, wherein said non-magnetic drill collar is constructed substantially of stainless steel.

11. The non-magnetic drill collar of claim 10, further comprising an intermediate buffer layer interposed between said stainless steel of said non-magnetic drill collar and said at least one non-magnetic hardfacing composition forming said non-magnetic helical bands, wherein said intermediate buffer layer comprises at least one non-magnetic metallic alloy.

12. The non-magnetic drill collar of claim 11, wherein
said intermediate buffer layer is thermally fused with said outer peripheral surface; and
said at least one non-magnetic hardfacing composition is thermally fused with said intermediate buffer layer.

13. The non-magnetic drill collar of claim 11, wherein said intermediate buffer layer has a thickness of between about 0.060 inch and about 0.090 inch.

14. The non-magnetic drill collar of claim 9, wherein said helical bands project outwardly of said outer peripheral surface not more than about 0.25 inch.

15. The non-magnetic drill collar of claim 9, wherein said coupler is configured to form a threaded connection.

16. The non-magnetic drill collar of claim 9, wherein said couplers comprise at least one coupler configuration selected from a threaded male pin-type coupler and a threaded female box-type coupler.

17. A non-magnetic drill collar for use in well-drilling operations, said non-magnetic drill collar comprising:
a longitudinally extending tubular wall having an outer peripheral surface, an inner bore defining a longitudinal axis, and opposing ends, each opposing end including a coupler configured to enable coupling of said non-magnetic drill collar to a rotary drill string;
a raised pattern of helical bands evenly spaced about said outer peripheral surface, each said helical band comprising
at least one non-magnetic hardfacing composition applied to said outer peripheral surface, said at least one non-magnetic hardfacing composition containing tungsten carbide,
a length of at least about three inches,
a width of at least about 0.5 inch,
a spacing between said helical bands of at least about 0.9 inch, and
a helical-band angle not less than about 30 degrees relative to said longitudinal axis;
an intermediate buffer layer interposed between said stainless steel of said non-magnetic drill collar and said at least one non-magnetic hardfacing composition forming said helical bands, wherein said intermediate buffer layer comprises at least one non-magnetic metallic alloy;
wherein said non-magnetic drill collar is constructed substantially of stainless steel;
wherein said intermediate buffer layer is thermally fused with said outer peripheral surface;
wherein said at least one non-magnetic hardfacing composition is thermally fused with said intermediate buffer layer;
wherein said intermediate buffer layer has a thickness of between about 0.060 inch and about 0.090 inch;
wherein said helical bands project outwardly of said outer peripheral surface not more than about 0.2 inch;
wherein said coupler is configured to form a threaded connection; and
wherein said couplers comprise at least one coupler configuration selected from a threaded male pin-type coupler and a threaded female box-type coupler.

18. The non-magnetic drill collar of claim 19, further comprising set of instructions; and
wherein said non-magnetic drill collar is arranged as a kit.
